(19) United States
(12) Patent Application Publication
(10) Pub. No.: US 2004/0067007 A1
(43) Pub. Date: Apr. 8, 2004

(54) Method and system for transmission in an optical network

(76) Inventors: Carl-Johan Arbeus, Stockholm (SE); Stig Axel Isaksson, Ronninge (SE)

Correspondence Address: ERICSSON INC., 6300 LEGACY DRIVE, M/S EVR C11, PLANO, TX, 75024, US

(21) Appl. No.: 10/470,852

(22) PCT Filed: Jan. 31, 2001
(86) PCT No.: PCT/EP01/01036

(51) Int. Cl. G02B 6/26; G02B 6/42

(52) U.S. Cl. 385/15

(57) ABSTRACT

A connection node (13) for an optical communication network (10) comprises a plurality of connection units (21). Each of the connection units (21) includes an associated add/drop filter unit (22) having an add filter and a drop filter for adding and dropping signals of specific wavelengths channels to and from light running in two opposite path directions (A, B). The add/drop filter units (22) are arranged along the light paths such that the light in each direction (A, B) first pass through all drop filters and then through al add filters. The connection node may be a multinode comprising a main node (13M) and at least one extension node (13E), each comprising a plurality of west and east connection units (21w, 21e) having associated add/drop filter units (21w, 21e). The add/drop filter units (22) of the main and extension nodes (13M, 13E) are then arranged in an intertwined manner along the light paths.

### TECHNICAL FIELD

The present invention relates generally to a method and a system for transmission of light signals in an optical fibre network. More specifically, the invention relates to the minimisation of optical power losses in network connection nodes, having optical filtering.

### BACKGROUND OF THE INVENTION AND PRIOR ART

Optical transmission in fibres is more and more used today as an alternative to electrical transmission in metallic cables, in particular for digitally encoded signals. Optical transmission offers greater capacity by employing Wavelength Division Multiplexing WDM such that a channel used for communication is defined by a specific light wavelength. In this way, a plurality of channels may at the same time be assigned to and transmitted on one single fibre carrier since no interference occurs between the different active channel wavelengths. The signal is bandpass filtered at the receiving side such that only the assigned light wavelength is detected and processed/decoded.

Various different types of communication networks may be configured using optical transmission fibres, such as for data communication and/or telephony. The energy losses of the light during transmission are generally considered to be quite low in this medium. However, if the light is transmitted over long distances, optical amplification along the way or at the receiver may still be required if the light signals become too weak for proper detection. Optical amplification may be done by electro-optical regeneration of the signal, which is well-known in the art. In short distance optical telecommunication networks, e.g. so-called metro networks, it may not be necessary to employ optical amplification due to the relatively short travelling distances of the signals. A power budget can be calculated for the transmission of light signals throughout the network, taking into account the energy losses in the fibres and in intermediate nodes, in order to predict the received signal quality and need for optical amplification. It is desirable to reduce or eliminate the need for such amplification, which is quite expensive to employ, by minimising the energy losses. The power budget is a major limiting factor of the network performance.

In FIG. 1 is shown a simplified example of a metro optical network 10 comprising optical fibres 11, 12 interconnecting a plurality of intermediate connection nodes 13, sometimes referred to as Optical Add-Drop Multiplexer-Metro network elements (OADM-M). The nodes 13 constitute points of connection with communicating parties 14 or other networks 15, of which only a few examples are shown. Each transmission link between two nodes 13 comprises at least two fibres 11 and 12, one for each direction of transmission, as will be explained below. The network 10 in this example is built as a bi-directional ring structure so that transmission from one point to another may go either clockwise or anti-clockwise, depending on, for example, which is the shortest route. Using this structure, it is possible to provide a so-called protection path as a back-up for each operating path. If an operating path 16 in one direction becomes inactivated for some reason, e.g. if the fibre is damaged, an ongoing communication on that path is switched over to a corresponding protection path 17 in the opposite direction which then becomes the operating path. The signals may be transmitted over the corresponding operating and protection paths simultaneously such that the receiver first detects signals from the operating path 16, and if no signals are detected from the operating path, starts to detect signals from the protecting path 17. In this way, the protection path is thus still able to provide connection to the receiving node, although maybe over a longer distance. There are other possible network structures which may use corresponding operating and protection paths. A connection may or may not be set up with such dual paths, e.g. depending on the availability of channels.

With reference to FIG. 2, each connection node 13 comprises at least one connection unit 21 for receiving, transmitting or routing signals. Each connection unit 21 is configured to drop or add signals of a specific light wavelength λ and comprises an optical add/drop filter unit 22, a Receive End Transponder RET 23 and a Transmit End Transponder TET 24. A main light flow, containing a plurality of wavelengths, may enter the connection unit 21 from two directions, such as clockwise and anti-clockwise running light flows in a ring structure. Any signal of the specific wavelength λ included in the main light flow from one direction A is dropped by a drop filter in the filter unit 22 and received by the RET 23. Further, a signal of the wavelength λ transmitted from the TET 24 is added by an add filter to the main light flow going in the other direction B. The RET 23 and the TET 24 are further connected to one or more end users or another communication network for further transmission, not shown. The connection unit 21 shown in FIG. 2 provides for communication to the left or west. Another corresponding connection unit is needed for communication to the right or east for signals of the same wavelength λ. Various available filtering techniques may be used in the filter unit 22, such as “thin film filtering”, which attempts to minimise the energy losses of the total light signal when going through the filter unit. However, this invention is not concerned with any specific method of filtering. Since each node 13 of the optical network typically comprises several connection units 21 through which the light must pass, the energy losses may be substantial such that some kind of optical amplification may become necessary. It is estimated that the light energy loss induced by each filter unit is in the order of 0.5-0.8 dB.

At present, the need for transmission capacity in optical networks is increasing. As the technique for optical transmission and filtering becomes more refined, it is possible to add more channels, i.e., wavelengths, to the transmitted light in order to increase the bandwidth capacity of the networks. On the other hand, this will deteriorate the power budget due to an increased number of connection units, i.e., filter units through which the light must pass.

### SUMMARY

It is an object of the present invention to minimise the energy losses of light signals in intermediate network nodes in order to reduce or eliminate the need for light amplification. Another object of the invention is to facilitate modification of existing network nodes when adding more connection units for expanding the traffic capacity. These and other objects are achieved by providing a method and an apparatus for connection to an optical communication network according to the invention. Each point of connection to the network constitutes a connection node including a plurality of connection units, each operating to add and drop signals of at least one specific wavelength to and from main light flows by means of add/drop filter units. According to one aspect of the invention, the add/drop filter units in each connection node are arranged along the light paths such that the main light flow in both directions first pass through all drop filters and then through all add filters. In this way, the number of filters that each individual light wavelength must pass, and thereby the light energy loss, is minimised. The connection node, or multinode, may comprise a main node and at least one extension node. According to another aspect of the invention, the extension node(s) may easily be added to an existing main node. The add/drop filter units of both the main amd extension nodes are then arranged in an intertwined manner along the main light flows such that the light always first pass through all drop filters and then through all add filters in the multinode.

### BRIEF DESCRIPTION OF THE DRAWINGS

The present invention will now be described in more detail and with reference to the accompanying drawings, in which:

FIG. 1 is a schematic view of a simplified optical network.

FIG. 2 is a block diagram of a connection unit providing a connection point for communicating parties or other networks.

FIG. 3 is a block diagram of a connection node comprising a plurality of connection units.

FIG. 4 is a block diagram of an expanded connection multinode, comprising a separate extension node added to an existing main node.

FIG. 5 is a block diagram of an exemplary logical connection multinode configuration.

FIG. 6 is a schematic view of an exemplary practical connection multinode configuration.

### DESCRIPTION OF PREFERRED EMBODIMENTS

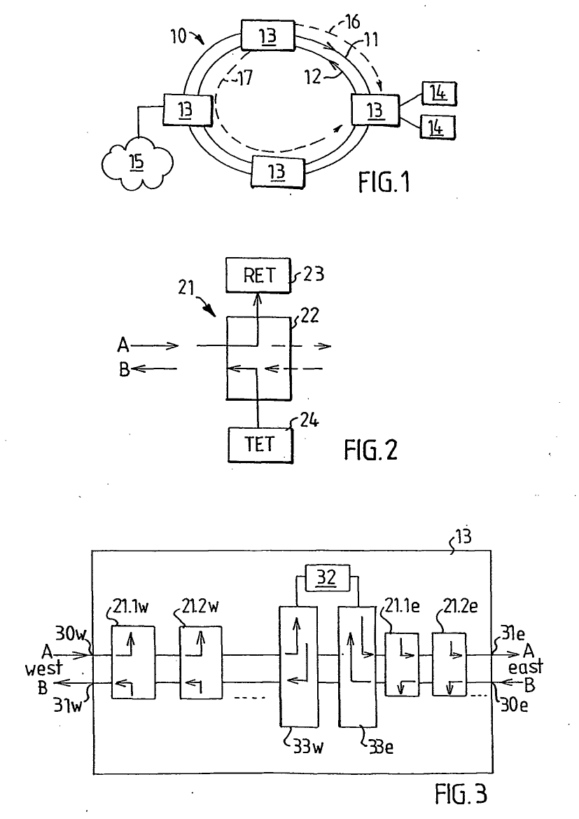

FIG. 3 illustrates a connection node 13, wherein main light flows, containing a plurality of wavelength channels, run through the connection node 13 in two directions A and B in at least one fibre for each direction, such as clockwise and anti-clockwise running signals in a bi-directional ring network structure, see FIG. 1. The connection node 13 includes a chain of plural connection units 21, interconnected in series by the fibres. A main light flow enters the connection node 13 in one direction A at a west input port 30w, runs through the connection units 21.1w, 21.2w . . . and 21.1e, 21.2e . . . one by one and exits the connection node 13 at an east output port 31e. Correspondingly, a main light flow in the other direction B enters the connection node 13 at an east input port 30e, runs through the connection units . . . 21.2e, 21.1e and . . . 21.2w, 21.1w one by one in the opposite order and exits the connection node 13 at a west output port 31w. In order to add or drop signals of a specific wavelength in both directions, two connection units are needed, one for each direction, as explained in connection with FIG. 2.

The applicant has recognised the importance of minimising the number of connection units in the chain that the main light flow must pass through in order to optimise the power budget. Therefore, the node 13 is divided into a west part for communication towards one side and an east part for communication towards the other side. The connection units are arranged having their drop filters close to the input ports and with its add filters close to the output ports. Thus, all drop filters for direction A and add filters for direction B are placed in the west part of the node 13, and all drop filters for direction B and add filters for direction A are placed in the east part of the node 13. For example, a west connection unit 21.1w operates to drop signals of the wavelength λ₁ from the light flow in direction A and add signals of the wavelength λ₁ to the light flow in direction B, and an east connection unit 21.1e is configured to drop signals of the wavelength λ₁ from the light flow in direction B and add signals of the wavelength λ₁ to the light flow in direction A. In this way, a pair of corresponding connection units 21.1w, 21.1e operates to communicate the wavelength λ₁ when transmitted in the two directions A and B.

Still referring to FIG. 3, each connection node 13 further comprises a control unit 32 for receiving and transmitting supervisory signals on a specific control channel wavelength, sometimes referred to as an Optical Supervisory Channel OSC. This channel is used for management communication, e.g. supervising the transponders. In order to drop signals from and add signals to this channel in both directions A and B, west and east control connection units 33w, 33e are arranged in the middle of the node 13, separating the remaining west connection units 21.1w, 21.2w . . . from the remaining east connection units 21.1e, 21.2e . . .

In practice, the equipment for a connection node 13 can be housed in two subracks mounted in one cabinet. The filter units are typically configured to each handle one specific wavelength channel, but it is possible to design filter units for plural wavelength channels.

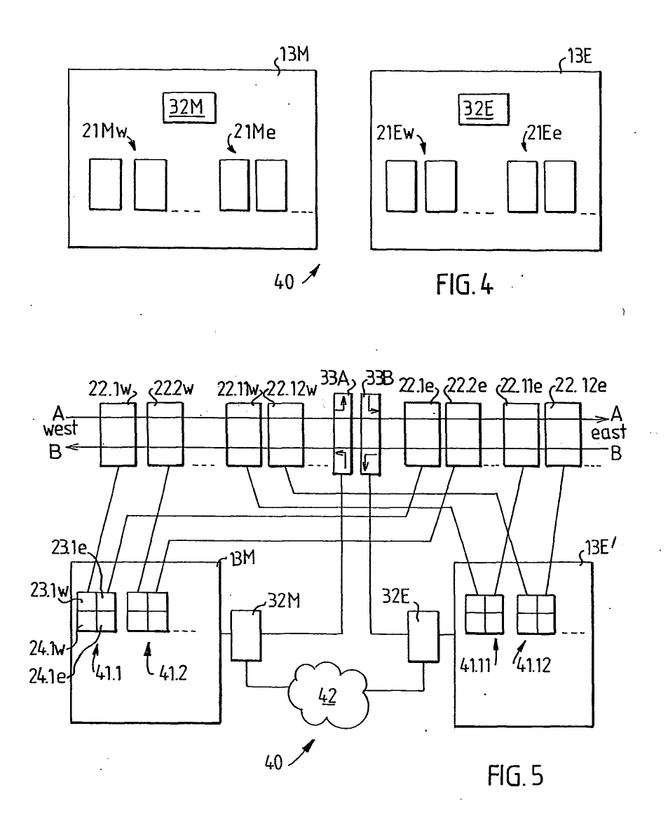

A typical connection node can have the capacity of adding and dropping up to 10 wavelength channels in each direction which can be utilised for 10 protected channels or 10+10 unprotected channels. It has been proposed to expand the capacity of such connection nodes up to 20 channels in each direction. In order to do this, more connection units 21 must be added to the already existing ones. Then, as illustrated in FIG. 4, new west and east connection units 21Ew, 21Ee are arranged in a separate extension connection node 13E which is added to the existing main connection node 13M, together forming a new expanded connection multinode 40. The main connection node 13M includes plural west and east connection units 21Mw, 21Me. The main node 13M and the extension node 13E may be housed in separate cabinets. The nodes 13M, 13E include separate control units 32M, 32E for the supervision of the transponders in the respective connection units, the control units 32M, 32E operating independently of each other. The benefits of adding a complete separate extension node instead of integrating new and existing equipment into one single node is that no modifications of the main node are necessary, regarding both hardware construction, such as housing, and software programming of the control unit 32M. For example, it is not necessary to implement a master/slave relationship, requiring new software in the respective control units. Therefore, the time and effort for adding more capacity is substantially reduced.

However, if the extension node 13E is simply installed at the side of the main node 13M in the light transmission path, the power budget will not be optimal, since the light will first pass through the west and east parts of one node and then through the west and east parts of the other node. Although the main node and the extension node can logically be regarded as two separate connection nodes, advantage can be taken by the fact that the two nodes are installed close to each other at the same site. Thus, the add/drop filter units of both nodes are arranged in an intertwined manner along the light paths such that the light in both directions first pass through all drop filters and then through all add filters, thereby minimising the number of filters that each individual light wavelength must pass.

FIG. 5 illustrates a connection multinode 40 where the light paths in two directions A, B pass through a chain of filter units 22 belonging to a main connection node 13M and an extension connection node 13E. In this example, the main node 13M provides connections for a first set of channels λ₁-λ₁₀ and the extension node 13E provides connections for a second set of channels λ₁₁-λ₂₀. The main node 13M comprises west filter units 22.1w-22.10w and east filter units 22.1e-22.10e. The extension node 13E comprises west filter units 22.11w-22.20w and east filter units 22.11e-22.20e. All west filter units 22.1w-22.20w are interconnected in an uninterupted sequence along the light paths on the “west sides” and all east filter units 22.1e-22.20e are interconnected in an uninterupted sequence along the light paths on the “east side”, as indicated in the figure. Between the west and east sides of the light paths are connection units 33A, 33B placed for dropping/adding signals of the control channel for communication with control units 32M, 32E of the main and extension nodes. The control units 32M, 32E may communicate with each other via a separate network 42, e.g. an Ethernet network. The filter units 22.1w-22.20w operate to drop signals of the respective channels λ₁-λ₂₀ in the A direction, and operate to add signals of the respective channels λ₁-λ₂₀ in the B direction. The filter units 22.1e-22.20e operate to add signals of the respective channels λ₁-λ₂₀ in the A direction, and operate to drop signals of the respective channels λ₁-λ₂₀ in the B direction.

The main node 13M further comprises RETs 23.1w-23.10w, 23.1e-23.10e and TETs 24.1w-24.10w, 24.1e-24.10e, and the extension node 13E comprises RETs 23.11w-23.20w, 23.11e-23.20e and TETs 24.11w-24.20w, 24.11e-24.20e. The RETs and TETS are associated with filter units 22.1w-22.20w, 22.1e-22.1e, respectively, as indicated in FIG. 5. For example, λ₁-signals dropped from direction A by the filter unit 22.1w are received by RET 23.1w and λ₁-signals transmitted from TET 24.1w are added by the filter unit 22.1w in direction B. Correspondingly, λ₁-signals dropped from direction B by filter unit 22.1e are received by RET 23.1e and λ₁-signals transmitted from TET 24.1e are added by the filter unit 22.1e in direction A.

In the example shown in FIG. 5, the RETs and TETs of both directions for each channel wavelength are logically grouped together as dual connection units, 41.1, 41.2 . . . in the main node 13M and 41.11, 41.12 . . . in the extension node 13E. It is preferable to physically arrange such dual units together if protected channels are used, as described above, with equal transmissions in both directions. For non-protected channels, this is not necessary and the RETs and TETs of the two directions for a channel wavelength may be placed independently of each other. In practice, various physical configurations are possible, such as grouping all west and east RET/TETs together in separate subracks in each node. However, it is important to arrange the associated filter units in the above described sequence in order to optimise the power budget.

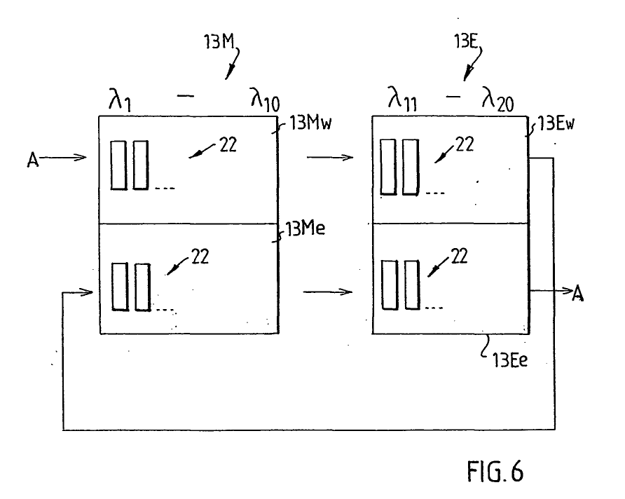

FIG. 6 illustrates how the filter units may be arranged, according to the invention, physically in a main cabinet 13M and an extension cabinet 13E, where each cabinet is divided into two subracks, such that the main cabinet comprises a west main subrack 13Mw and an east main subrack 13Me, and the extension cabinet comprises a west extension subrack-13Ew and an east extension subrack 13Ee. In this example, each subrack comprises 10 add/drop filter units 22 for adding/dropping signals of respective channels λ₁-λ₂₀. The shown arrows represent a main light flow in one direction A. Thus, the light flow first runs through 10 filter units of the west main subrack 13Mw which operate to drop signals from channels λ₁-λ₁₀, then through 10 filter units of the west extension subrack 13Ew which operate to drop signals from channels λ₁₁-λ₂₀. Next, the light runs through two control channel filter units, not shown, for east and west communication respectively. These control channel filter units may be arranged in either of the main or extension subracks or in a separate subrack/housing. After passing through the control channel filter units, the signal runs through 10 filter units of the east main subrack 13Me which operate to add signals to channels λ₁-λ₁₀, and finally through 10 filter units of the east extension subrack 13Ee which operate to add signals to channels λ₁-λ₂₀. Alternatively, it is possible to let the light flow pass through the filters in any order within each subrack, e.g. in the opposite order from λ₂₀ through λ₁ in the east subracks 13Ee, 13Me. Various other different combinations are possible of arranging the filter units in the different cabinets and subracks and the described example should not be seen as limiting the scope of the invention. For example, any number of filters for both west and east communication together with the associated TETs/RETs may be located in one cabinet each for the main and extension nodes respectively, as indicated in FIG. 4.

The invention as described herein, provides for flexible configurations of connection nodes in optical networks, and in particular, a simple way of expanding connection capacity without requiring modifications to already existing equipment and resulting in minimised light energy losses.

According to further possible embodiments of the invention, a connection multinode may comprise more than one extension node in addition to the main node, in order to further extend the connection capacity. For example, one main node and three extension nodes can be configured in an intertwined manner similar to that described above.

While the invention has been described with reference to specific exemplary embodiments, the description is only intended to illustrate the inventive concept and should not be taken as limiting the scope of the invention. Various alternatives, modifications and equivalents may be used without departing from the spirit of the invention, which is defined by the appended claims.

1. A connection node for providing connection with an optical communication network (10), the connection node (13) comprising a plurality of connection units (21), each having an associated add/drop filter unit (22) including an add filter and a drop filter for adding and dropping signals of specific wavelength channels to and from light running in two oposite path directions (A, B), characterised in that the add/drop filter units (22) are arranged along the light paths such that the light in each direction (A, B) first pass through all drop filters and then through all add filters.

2. A connection node according to claim 1, characterised in that the connection units (21) are divided along the light paths into west connection units (21w) for communication towards one side and east connection units (21e) for communication towards the other side, wherein signals of each wavelength channel is communicated by a west connection unit (21w) and a corresponding east connection unit (21e) in both directions (A, B).

3. A connection node according to claim 2, characterised in that the connection node (13) further comprises a supervising control unit (32) and two associated connection units (33A, 33B) arranged in the light paths between the west and east connection units for communicating signals of a control wavelength channel to and from the control unit (32).

4. A connection node according to claim 2, characterised in that the connection node is a multinode comprising a main node (13M) and at least one extension node (13E), each one comprising a plurality of west and east connection units (21w, 21e) including associated add/drop filter units (22w, 22e).

5. A connection node according to claim 4, characterised in that each of the main and extension connection nodes (13M, 13E) comprises a supervising control unit (32) and two associated connection units (33A, 33B).

6. A connection node according to claim 4, characterised in that the add/drop filter units (22) are arranged in an intertwined manner along the light paths such that the light in each direction (A, B) first passes through all drop filters of the main and extension nodes (13M, 13E) and then through all add filters of the main and extension nodes (13M, 13E).

7. A connection node according to claim 4, characterised in that the add/drop filter units (22) of each main and extension node (13M, 13E) are located in a separate housing.

8. A connection node according to claim 6, characterised in that in the add/drop filter units (22), each add filter is connected to an associated Transmit End Transponder TET (24) and each drop filter is connected to an associated Receive End Transponder RET (23), wherein the associated RETs and TETs are also located in the separate housing.

9. A connection node according to any of claims 4-8, characterised in that the main node (13M) provides connections for a first set of wavelength channels (λ₁-λ₁₀) and the at least one extension node (13E) provides connections for at least a second set of wavelength channels (λ₁₁-λ₂₀).

10. A connection node according to any of claims 1-9, characterised in that each of the connection units (22) provides a connection to the optical network for a communicating party (14) or another communication network (15).

11. An optical communication network comprising a plurality of connection nodes, characterised in that the connection nodes include at least one connection node according to any of claims 1-10.

12. A method of connecting to an optical communication network comprising a connection node (13) including a plurality of connection units (21), each having an associated add/drop filter unit (22) including an add filter and a drop filter for adding and dropping signals of specific wavelengths to and from light running in two oposite path directions (A, B), characterised by the steps of:
dropping signals from the light before the light runs through the add filters in each direction, and
adding signals to the light after the light has run through the drop filters in each direction.

13. A method according to claim 12, characterised in that the connection node is a multinode comprising a main node (13M) and at least one extension node (13E), each main and extension node comprising a plurality of connection units (21), and that the add/drop filter units (22) of the main and extension nodes (13M,13E) are arranged in an intertwined manner along the light paths, wherein the steps of dropping and adding signals are performed such that light in each direction (A, B) first pass through all drop filters of the main and extension nodes (13M, 13E) and then through all add filters of the main and extension nodes (13M, 13E).

14. The method according to claim 12, characterised by the further steps of:
providing connections for a first set of wavelength channels (λ₁-λ₁₀) by the main node (13M) and
providing connections for at least a second set of wavelength channels (λ₁₁-λ₂₀) by the at least one extension node (13E).

15. A method of expanding connection capacity in an optical communication network (10) comprising a plurality of connection nodes (13M), each including a plurality of connection units (21), each having an associated add/drop filter unit (22) including an add filter and a drop filter operating to add and drop signals of a first set of wavelength channels (λ₁-λ₁₀) to and from light running in two oposite path directions (A, B), characterised by the step of:
adding at least one extension node (13E), capable of adding and dropping signals of at least a second set of wavelength channels (λ₁₁-λ₂₀), to an existing main node (13M), wherein the add/drop filter units (22) of the main and extension nodes (13M,13E) are arranged in an intertwined manner along the light paths such that light in each direction (A, B) first pass through all drop filters of the main and extension nodes (13M, 13E) and then through all add filters of the main and extension nodes (13M, 13E).
